(19) United States
(12) Patent Application Publication
(10) Pub. No.: US 2005/0047278 A1
(43) Pub. Date: Mar. 3, 2005

(54) High-power transmission acoustic antenna

(76) Inventors: Daniel Andreis, Mandelieu La Napoule (FR); Sylvie Ponthus, Valbonne (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/497,659

(22) PCT Filed: Dec. 6, 2002
(86) PCT No.: PCT/FR02/04219

(30) Foreign Application Priority Data
Dec. 7, 2001 (FR) 01/5864

(51) Int. Cl. B06B 1/06

(52) U.S. Cl. 367/162

(57) ABSTRACT

The invention relates to high-frequency antennas with high transmission power.

It consists in making the backing layer (201) of such an antenna with a heat-conductive foam. It enables the transmission power to be appreciably doubled.

The present invention relates to acoustic antennas, namely devices used for the transmission, by electrical signals, of acoustic, sonic or ultrasonic waves in water. Such antennas are used especially in sonar. The invention can be used, in particular, to send high acoustic power, or even very high acoustic power, with such an antenna.

It is known, in the field of signal processing and especially in sonar, that the greater the duration T of the pulses sent, the greater will be the processing gain which is proportional to the product BT (B: frequency band), and hence the greater the increase in detection performance.

There are known high-frequency transducers, typically used for transmission frequencies of over 50 KHz, constituted by a stack of layers known as “front” layer(s) (thin matching layers and/or tight-sealing membrane), a layer of active material (electrical/acoustic transduction) and layer(s) known as backing layer(s).

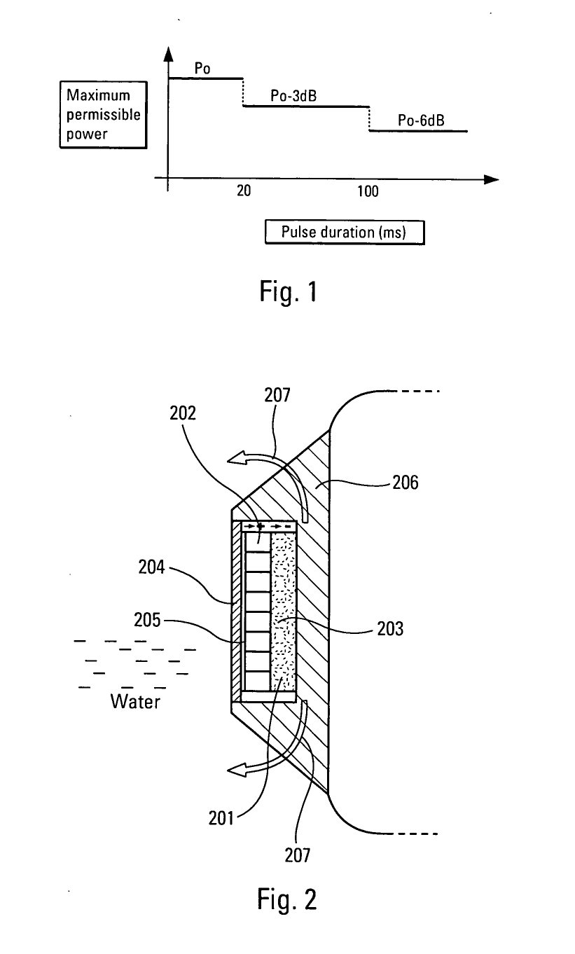

The phenomena of heating in the layer of active material, due to dielectric and mechanical losses, restrict the transmission peak power when the duration of the pulse is increased. Thus, for a material consisting of piezoelectric ceramics, the typical functioning of a transducer roughly follows the profile shown in FIG. 1.

This limiting of the level of allowable power for the long pulses is related to the use of materials having low heat conductivity for the matching thin layers, the backing as well as the tight-sealing membrane. Indeed, in the prior art, these elements are made out of materials comprising an elastomer matrix (such as rubbers, polyurethanes and silicones) or resin, especially epoxide, giving rise to inefficient discharge of the heat generated by the transducer into the carrier structure or into seawater.

There are known heat-conductive materials that take the form of foams. Reference may be made especially to the metal foams made of aluminum, nickel, nickel-chrome, copper or steel, as well as to non-metal foams made of carbon or silicon carbide. These foams have heat conductivity about 20 times greater than that of the charged epoxy resin type of composite materials used as matching or backing materials in the high-frequency transducers corresponding to the prior art. It is 50 times greater than that of rubbers constituting the impervious membranes used in these transducers.

From the German patent 19 623 035 filed by the firm STN Atlas, there is a known low-frequency transducer whose horn and/or rear mass are constituted by an expanded metal whose density is adjusted to obtain a determined resonance frequency.

To this end, the horn and/or the rear mass are obtained by molding the basic metal with an appropriate dose of foaming agent. However, this method of manufacture is difficult to implement and control, and this is a serious drawback.

To overcome these drawbacks, the invention proposes a high-frequency acoustic antenna with high transmission power comprising a stack formed by at least one front protection layer, at least one layer of active material and at least one reflector-forming backing layer, chiefly characterized in that this backing layer is constituted by a heat-conductive foam.

According to another characteristic, the backing layer is bonded to one face of the layer of active material and is applied on the other face to a metal support in contact with the medium into which the antenna is plunged, and the layer of active material is formed by columns of piezoelectric ceramic.

According to another characteristic, the backing layer is formed by metal foam.

According to another characteristic, this metal foam is compressed.

According to another characteristic, a printed circuit for electric connection is inserted between the front layer and the layer of active material and a metal film is inserted between the active layer and the backing layer and forms the cold point

According to another characteristic, it comprises a metal film inserted between the front layer and the layer of active material and forming the cold point, and a printed circuit and an insulating film inserted between the layer of active material and the backing layer.

According to another characteristic, the high-frequency acoustic antenna with high transmission power comprises a stack formed by at least one front protection layer, at least one layer of active material and at least one reflector-forming backing layer, the layer is constituted by a plate made of open-cell metal foam filled with a material achieving acoustic matching, the front layer is bonded to the layer of active material by means of metal film forming the cold point, and it comprises a printed circuit inserted between the layer of active material and the backing layer.

According to another characteristic, the backing layer is constituted by a heat-conductive foam.

According to another characteristic, the acoustic antenna constitutes the transmission antenna or the transmission/reception antenna of an underwater imaging sonar.

Other features and advantages of the invention shall appear clearly in the following description, presented by way of a non-restrictive example with reference to the appended figures, of which:

FIG. 1 is the graph of the maximum power/pulse duration of a prior art transducer; and

FIGS. 2 to 5 show views in section of transducers according to different embodiments of the invention.

FIG. 2 shows a view in a vertical plane section of a high-frequency transducer laid out to form a sonar antenna according to the invention. This antenna is formed by several columns of juxtaposed transducers (here they are piezoelectric ceramic cubes).

According to a preferred embodiment of the invention, the rear part forming the “backing” of each column is constituted by a plate made of metal foam.

Such a foam is commercially available in the form of plates. One example of an embodiment of the invention uses a product referenced DUOCEL 10 PPI, available from the firm ERG (USA). This open-cell foam is based on aluminum and possesses the following characteristics:

density: 0,21 g/cm³

usual thickness of the plates: 13 mm

diameter of the cells: ≅0.6 mm with a porosity of 10 PPI

heat conductivity of the ligaments: 237 W/mK

heat conductivity of the foam: 3.04 W/mK

The selected plate is advantageously cold-compressed mechanically so as to obtain the desired density. This also increases its resistance to pressure. Thus, the backing 201 was obtained in one exemplary embodiment by reducing the thickness to 4 mm to obtain a density in the range of 0.7 g/cm³.

In the preferred embodiment, the backing constitutes the electric cold point. It is made in one piece which, after being shaped to the right dimensions, is bonded to the columns of ceramic 202 by means of an epoxy bonder, via a metal film 203 forming the ground plane. The antenna proper is then completed by the front layer or layers 204 positioned on the ceramic columns through a printed circuit 205 provided with tracks which, according to a known technique, provide electrical power to each column of transducers.

As can be seen in FIG. 2, the unit is placed in a metal support 206. Thus the heat is discharged into the water through the backing which is put into direct contact with this support. Advantageously, a paste favoring the heat exchanges is inserted between the foam and the support. In FIG. 2, the heat flux is indicated by arrows 207.

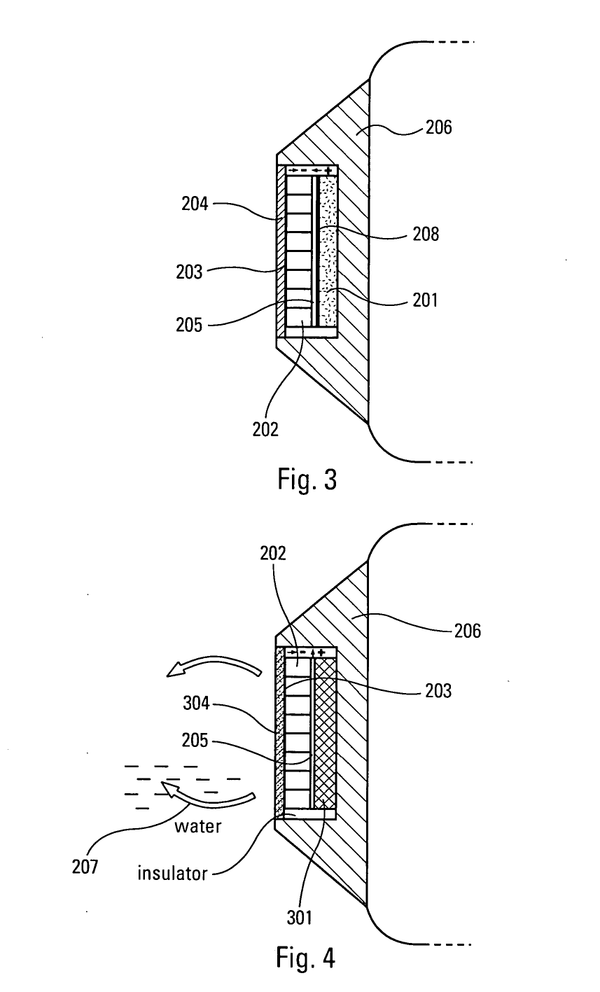

According to a second embodiment, shown in FIG. 3, the cold point is placed on the front layer(s) side, the hot point being located on the backing side. In this variant, the printed circuit 205 provided with tracks is inserted between the columns of ceramics 202 and the foam 201. Furthermore, an electrically insulating thin film 208 is placed between the printed circuit and the foam, the thickness and the material of this film being chosen so as to let the heat flux pass through. The metal film 203 forming the ground plane is inserted between the front layers 204 and the ceramic columns 203.

According to a third embodiment, shown in FIG. 4, only the front layer(s) are constituted by a foam 304 made of conductive material. This foam is advantageously an open-cell metal foam so as to be impregnated with the material generally used for the front layers, polyurethane or elastomer in the case of a membrane, charged or uncharged epoxy resin in the case of matching thin layers. The foam then serves as a metal skeleton enabling the thin-layers to be made heat-conductive.

The desired density is adjusted by means of the filler material and the foam therefore does not need to be compressed for this function. However, it may advantageously be compressed to increase the heat exchanges. Such charged foams are known inter alia from the U.S. Pat. No. 3,707,401 filed on 26 Dec. 1972.

In this embodiment, only one printed circuit 205 is inserted between the columns of ceramics and the backing 301, which is made in one piece out of a classic material that can be used to obtain impedance matching, for example a low-density alveolar material.

As in the second embodiment, a metal film 203 is inserted between the front layer(s) and the columns of ceramics.

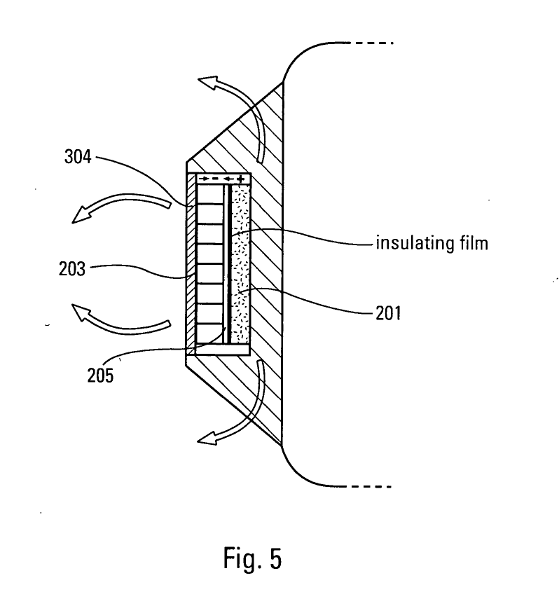

According to a fourth embodiment, shown in FIG. 5, the backing 201 and the front layer(s) 304 are made out of conductive material, preferably metal foam for the backing and filled metal foam for the front layers.

According to one variant, the metal films, inserted either between the backing and the columns of ceramics or between the front layers and the columns of ceramics, are eliminated in taking advantage of the conductive character of the metal foams.

In the preferred embodiment, the ceramic reaches a temperature of 65° C. for an electric power density of 110 W/cm², as against only 60 W/cm² at the same temperature for a backing made of a material that is not heat-conductive.

It is then possible with the invention, to obtain an increase by almost a factor of 2 in the duration of the pulse emitted at a constant power level close to the maximum allowable value.

Without departing from the framework of the invention, the embodiments corresponding to the FIGS. 4 and 5 may be the object of variants consisting in inverting the hot and cold points. In this case, a metal film separates the backing from the columns of transducers, and the front layer(s) are then electrically insulated between each column.

1. High-frequency acoustic antenna with high transmission power comprising a stack formed by at least one front protection layer (204), at least one layer of active material (202) and at least one reflector-forming backing layer (201), constituted by a heat-conductive metal foam, characterized in that the metal foam constituting the backing layer is compressed and that the backing layer (201) is inserted between the layer of active material (202) and a metal support (206) in contact with the medium into which the antenna is plunged.

2. Antenna according to claim 1, characterized in that the layer of active material (202) is formed by columns of piezoelectric ceramic.

3. Antenna according to any of the claims 1 to 2, characterized in that it comprises a printed circuit for electric connection (205) inserted between the front layer (204) and the layer of active material (202) and a metal film inserted between the layer of active material (202) and the backing layer (201) and forming the cold point

4. Antenna according to any of the claims 1 to 3, characterized in that it comprises a metal film (203) inserted between the front layer (204) and the layer of active material (202) and forming the cold point, and a printed circuit (205) and an insulating film inserted between the layer of active material and the backing layer.

5. High-frequency acoustic antenna with high transmission power comprising a stack formed by at least one front protection layer (204), at least one layer of active material (202) and at least one reflector-forming backing layer (201), characterized in that the front protection layer (304) is constituted by a plate made of open-cell metal foam filled with a material achieving acoustic matching, the front layer is bonded to the layer of active material (202) by means of a metal film (203) forming the cold point, and in that it comprises a printed circuit (205) inserted between the layer of active material and the backing layer.

6. Antenna according to claim 5, characterized in that the backing layer (201) is formed by a thermally conductive metal foam.

7. An acoustic antenna according to the claims 1 to 6, characterized in that it constitutes the transmission antenna or the transmission/reception antenna of an underwater imaging sonar.
